(19) United States
(12) Patent Application Publication
(10) Pub. No.: US 2024/0350954 A1
(43) Pub. Date: Oct. 24, 2024

(54) COALESCING FILTER INSERT, PRESSURE VESSEL, AND SEALING ELEMENT

(71) Applicant: MANN+HUMMEL GmbH, Ludwigsburg (DE)

(72) Inventor: Klemens DWORATZEK, Edingen (DE)

(21) Appl. No.: 18/763,272

(22) Filed: Jul. 3, 2024

Related U.S. Application Data
(63) Continuation of application No. PCT/EP2022/082395, filed on Nov. 18, 2022.

(30) Foreign Application Priority Data
Jan. 10, 2022 (DE) 102022100406.6

(51) Int. Cl. B01D 46/00; B01D 46/24; B01D 46/42; F16J 15/32

(52) U.S. Cl. CPC B01D 46/003; B01D 46/009; B01D 46/2403; B01D 46/4227; F16J 15/32; B01D 2265/06; B01D 2271/027

(57) ABSTRACT

A coalescing filter insert for installation in a pressure vessel of a liquid separator has a coalescing separator element separating liquid/aerosol from a gas flow. An annular disk-shaped flange at an end face of the separator element can be exchangeably arranged between a cover and a cylindrical body of the pressure vessel. The flange has a support surface at a radially outer rim thereof to be supported on an upper support region of the pressure vessel body. A seal element is arranged at the support surface of the flange such that, in a position of use, it seals the interior of the pressure vessel against ambient pressure. A seal element extension of the seal element extends radially outwardly away from the flange support surface and, arranged between cover and body of the pressure vessel, projects through the pressure vessel in the position of use.

### CROSS-REFERENCE TO RELATED APPLICATIONS

This application is a continuation application of international application No. PCT/EP2022/082395 having an international filing date of Nov. 18, 2022, and designating the United States, the international application claiming a priority date of Jan. 10, 2022, based on prior filed German patent application No. 10 2022 100 406.6, the entire contents of the aforesaid international application and the aforesaid German patent application being incorporated herein by reference.

### BACKGROUND

The invention concerns a coalescing filter insert for installation in a pressure vessel of a liquid separator, comprising at least one hollow cylinder-shaped separator element configured for separating liquid and/or aerosol from a gas flow by means of the coalescence principle; an annular disk-shaped flange arranged at an end face at the separator element and arrangeable exchangeably between a cover of the pressure vessel and a cylinder-shaped body of the pressure vessel, wherein the flange comprises a support surface at least at its radially outer rim which is configured to be supported on an upper support region of the body of the pressure vessel facing the cover; and at least one seal element arranged in such a way at the support surface of the flange that, in position of use of the coalescing filter insert, it seals a hollow-cylindrical interior of the pressure vessel, configured for accommodating the coalescing filter insert, in relation to the ambient pressure.

The invention concerns furthermore a pressure vessel comprising a housing opening, a cylinder-shaped body configured to accommodate a coalescing filter insert, and an in particular annular disk-shaped cover with a central clean air outlet for closing the housing opening, and comprising at least one seal element cutout in which the seal element is arrangeable seal-tightly between the housing body and the cover.

The invention concerns also a liquid separator with an aforementioned pressure vessel and an aforementioned coalescing filter insert, as well as a method for exchanging a coalescing filter insert of the aforementioned kind mountable in an aforementioned pressure vessel.

Liquid separators, for example, air/oil separator elements for separating oil aerosol from air, can be used, for example, for removing oil from compressed air in compressed air systems which are supplied by an oil-lubricated connection element, for example, a compressor or a vacuum pump. Such a liquid separator comprises a filter insert configured for separating oil from air and a pressure vessel or pressure-resistant vessel of the connection element.

The air laden with oil flows through a raw air inlet into the pressure vessel in order to subsequently flow through the filter insert, which comprises at least one filter element or separation element configured for separation of oil from raw air, for example, a main separator and a post separator, and, finally, exit from the housing in the purified state through the clean air outlet.

The filter insert functions according to the coalescence principle. The at least one hollow-cylindrically configured separator element is configured as a hollow cylindrical coalescing device which coalesces the fine oil droplets to larger oil drops which, due to the force of gravity, precipitate in downward direction in the air/oil separator element and downstream thereof. The precipitating oil drops are drained through at least one drainage conduit or at least one drainage pipe.

DE 10 2014 002 719 A1 discloses a coalescing filter insert of the aforementioned kind as well as a pressure vessel of the aforementioned kind. In this coalescing filter insert, the seal element is of an L-shaped configuration and is attached to the radially outer rim of the flange. Furthermore, a coalescing filter insert with a U-shaped or V-shaped seal element fastened to the radially outer rim of the flange is described in the publication WO 2011/088290 A1. In the position of use of these coalescing filter inserts, the seal element is accommodated in the housing of the pressure vessel, respectively. From the exterior side of the pressure vessel, the seal element thus cannot be seen (compare FIGS. 3 to 6 of DE 10 2014 002 719 A1 as well as FIGS. 6 and 7 of WO 2011/088290 A1).

In prescribed servicing intervals, the coalescing filter insert is to be exchanged. In this context, the length of the servicing intervals depends on the design of the separator element or on the design of the liquid separator.

It is an object of the invention to further develop a coalescing filter insert of the aforementioned kind, a pressure vessel of the aforementioned kind as well as a seal element of the aforementioned kind in such a way that the coalescing filter insert is mountable simply and without errors in the pressure vessel as well as removable from the pressure vessel. In particular, mounting and demounting of the coalescing filter insert in the pressure vessel are to be simplified.

### SUMMARY

This object is solved by a coalescing filter insert characterized in that the seal element comprises at least one radially outwardly extending seal element extension which extends away from the support surface and is arrangeable between the cover and the cylinder-shaped body of the pressure vessel and is configured such that the seal element extension, in position of use of the coalescing filter insert, projects through the pressure vessel.

The object is further solved by a pressure vessel characterized in that the seal element cutout comprises at least one radial cutout region which extends from a pressure vessel inner side facing the interior of the pressure vessel all the way to a radially outwardly arranged pressure vessel outer side facing away from the interior of the pressure vessel and loaded by the ambient pressure.

The object is further solved by a seal element as disclosed.

Advantageous embodiments and expedient further developments of the present invention are characterized in the respective dependent claims.

The present invention is based on the seal element comprising at least one seal element extension extending radially outwardly away from the flange which can be arranged between the cover and the cylinder-shaped body of the pressure vessel and is configured such that the seal element extension, in the position of use of the coalescing filter insert, projects through the pressure vessel, in particular through a housing wall of the cylinder-shaped body and/or through the cover.

In other words, the seal element extension is configured such that, in the position of use of the coalescing filter insert, it extends from a pressure vessel inner side facing the interior of the pressure vessel all the way to a radially outwardly arranged pressure vessel outer side facing away from the interior of the pressure vessel and exposed to the ambient pressure.

The seal element extension projecting in the position of use of the coalescing filter insert through the pressure vessel, for example, through the body and/or through the cover of the pressure vessel, has the advantage that the seal element extension is visible from the exterior of the pressure vessel. This makes it possible to detect, when a pressure vessel is closed, whether a filter insert is arranged or not in the pressure vessel. In this way, the safety when operating the liquid separator is increased.

Preferably, the seal element comprises a seal body, which surrounds the outer rim of the flange and which is in particular configured of an annular shape, and at least one seal element extension which extends radially outwardly away from the seal body. Seal body and seal element extension are preferably of a one-piece configuration and, further preferred, are monolithically embodied. Seal body and seal element extension are preferably manufactured as one piece by a shaping manufacturing process, in particular casting process, preferably injection molding process, preferably produced in a single casting step. A preferred material for the seal element is at least one elastic, in particular rubber-elastic, material, for example, at least one elastomer such as rubber or a thermoplastic elastomer.

Preferably, the seal element extension, at its radially outer rim, comprises at least one radially outer end surface, in particular visible surface, which is configured for applying at least one marking or at least one code. This radially outer end surface can be arranged at an angle in relation to the radius of the flange. For example, the seal element extension can be configured L-shaped or substantially L-shaped and comprise a first stay which extends through the pressure vessel as well as a second stay which is embodied perpendicularly or substantially perpendicularly in relation to the first stay, wherein the second stay is associated with the radially outer end surface.

At least one marking embodied for identification of the seal element and/or of the filter insert, for example, at least one code embodied for identification of the seal element and/or of the filter insert, for example, at least one bar code, code of stripes, code of lines, barcode, quick response code, or at least one code embodied for identification by means of electromagnetic waves, for example, a so-called R [adio] F [requency] ID [entification] code, can be arranged on this radially outer end surface. This makes it possible, when the pressure vessel is closed, to identify the seal element or the filter insert from the exterior. In this way, when servicing the liquid separator, it can be checked already prior to opening of the pressure vessel whether the correct replacement part for exchange of the coalescing filter insert is available. Since after the pressure vessel has been opened, the latter usually cannot be seal-tightly closed by the originally installed coalescing filter insert, the liquid separator usually cannot be further operated after opening of the pressure vessel if no matching replacement part for exchanging the coalescing filter insert is present. The possibility of identifying the seal element and/or the coalescing filter insert thus significantly facilitates servicing of the liquid separator.

In case an RFID code is arranged on the radially outer end surface of the seal element, it can be electronically read out. The RFID code can comprise as information, for example, the manufacturing date of the coalescing filter insert, a parts number of the coalescing filter insert, information in regard to the operating manual of the filter insert, or the date of last servicing of the filter insert.

The marking or the code can be glued to the radially outer end surface or can be integrated as a component into the radially outer end surface.

A further advantage of the present invention is that by means of the seal element extension it can be ensured that the coalescing filter insert can be operated only in a respective matching pressure vessel. In order to be able to arrange the seal element extension seal-tightly between cover and body of the pressure vessel, the pressure vessel comprises a seal element cutout with at least one cutout region extending through the cover and/or the body of the pressure vessel and embodied, for example, like a stay. This cutout region extends from a pressure vessel inner side to a pressure vessel outer side, i.e., through at least one housing wall of the pressure vessel, and is configured to seal-tightly accommodate the seal element extension. In this context, the cutout region for accommodating the seal element extension can be arranged in the body and/or in the cover of the pressure vessel.

The seal element cutout, in particular the radial cutout region, of the pressure vessel is advantageously embodied so as to correspond to the geometry of the seal element, in particular of the seal element extension. This makes it possible to match a filter insert and pressure vessel to each other. In this way, it can be identified by means of the geometry of the seal element whether the coalescing filter insert is designed for installation in the pressure vessel.

By means of the geometry of the seal element extension, the coalescing filter insert can thus be designed such that it can be seal-tightly used only in a pressure vessel which corresponds to the seal element.

A further advantage of the present invention is that the seal element extension facilitates demounting of the filter insert. Thus, after opening of the cover of the pressure vessel, the coalescing filter insert can be released in a leverage-type action from the body of the pressure vessel by lifting the seal element extension, which is, for example, tab-shaped. The at least one seal element extension facilitates thus gripping and lifting of the coalescing filter insert when being demounted from the pressure vessel.

The seal element can comprise one or a plurality of seal element extensions extending radially outwardly away from the flange. It is particularly advantageous for removal of the coalescing filter insert when the seal element comprises at least two seal element extensions which are arranged symmetrically at the seal element.

For stability reasons, the seal element extension is advantageously embodied as one piece together with the seal element.

Independent thereof or in combination therewith, the seal element comprises in an advantageous embodiment of the present invention a seal body, which surrounds the outer rim of the flange and which is embodied in particular in an annular shape, and at least one grip element which extends away from the flange radially inwardly and connects at least two spaced apart regions of the annular seal body to each other. This grip element facilitates handling of the coalescing filter insert during its installation in the pressure vessel or removal from the pressure vessel. In addition, the grip element reduces the risk of injury when gripping the coalescing filter insert because it facilitates handling of the coalescing filter insert, in particular because the grip element is arranged at the level of the seal element. Seal body and grip element are preferably of a one-piece configuration and further preferred are monolithically configured. Seal body and grip element are preferably manufactured as one piece by a shaping manufacturing process, in particular casting process, preferably injection molding process, preferably produced in a single casting step. A preferred material for seal element and grip element is at least one elastic, in particular rubber-elastic material, for example, at least one elastomer such as rubber or a thermoplastic elastomer.

A preferred material for the grip element is at least one elastic, may be rubber-elastic, material, for example, at least one elastomer such as rubber. Light coalescing filter inserts can be handled with a grip element of elastic material. In case of coalescing filter inserts which make it necessary with respect to weight and contour, a core of a strong material, for example, of metal such as sheet metal, of wood, or of plastic material, can be added to the grip element.

The present invention concerns furthermore a liquid separator comprising a pressure vessel according to the invention as well as a coalescing filter insert according to the invention arranged in the pressure vessel. The liquid separator may be characterized in that the radial cutout region of the pressure vessel is embodied corresponding to the geometry of the seal element, in that the radial cutout region may be configured corresponding to the geometry of the seal element extension.

The present invention concerns finally a method for exchanging a coalescing filter insert of the aforementioned kind installed in a pressure vessel of the aforementioned kind, wherein, for removal of the coalescing filter insert from the housing, at least one seal element extension extending radially outwardly away from the flange is lifted and/or the seal element is lifted by means of at least one grip element of the seal element extending radially inwardly away from the flange.

### BRIEF DESCRIPTION OF THE DRAWINGS

There are different possibilities in regard to embodying and further developing the teaching of the present invention in an advantageous manner. Further embodiments, features, and advantages of the present invention will be explained in the following in more detail inter alia with the aid of the embodiments illustrated in FIGS. 1 through 10.

FIG. 1 shows in exploded illustration an embodiment of a liquid separator according to the present invention with a first embodiment for a coalescing filter insert according to the present invention and an embodiment for a pressure vessel according to the present invention, wherein the coalescing filter insert comprises a first embodiment for a seal element according to the present invention.

FIG. 2 shows in perspective illustration the liquid separator of FIG. 1 in the assembled state.

FIG. 3 shows in section illustration the liquid separator of FIG. 2.

FIG. 4 shows in section illustration the coalescing filter insert of FIG. 1.

FIG. 5 shows in section illustration the seal element of the coalescing filter insert of FIG. 1.

FIG. 6 shows in plan view the seal element of the coalescing filter insert of FIG. 1.

FIG. 7 shows in perspective illustration a second embodiment for a seal element according to the present invention.

FIG. 8 shows a detail view of the radially outer rim of the seal element extension of the seal element of FIG. 6 or of FIG. 7.

FIG. 9 shows in section illustration a second embodiment for a coalescing filter insert according to the present invention which comprises a third embodiment for a seal element according to the present invention.

FIG. 10 shows in perspective illustration the coalescing filter insert of FIG. 9.

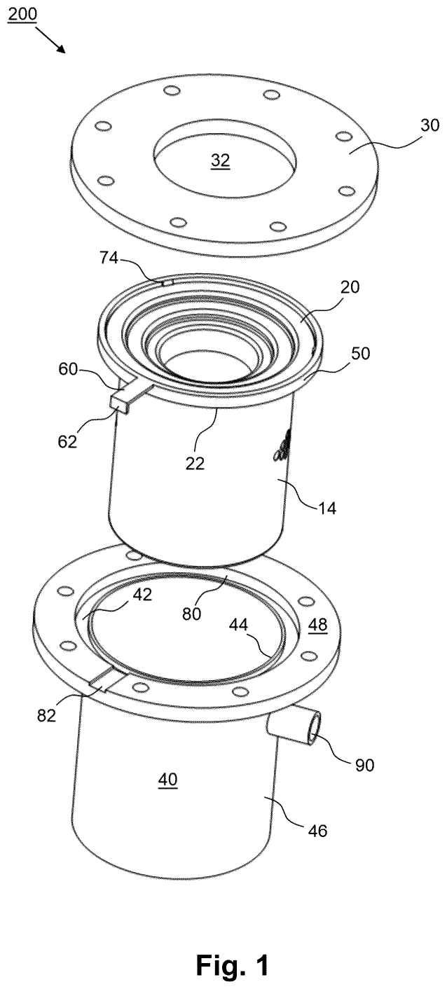

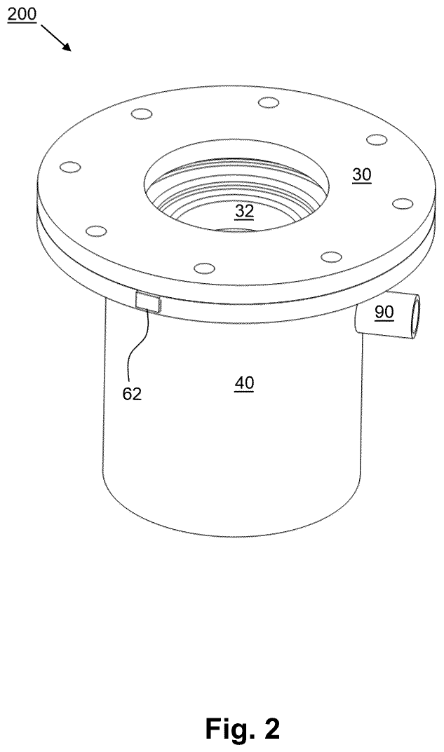

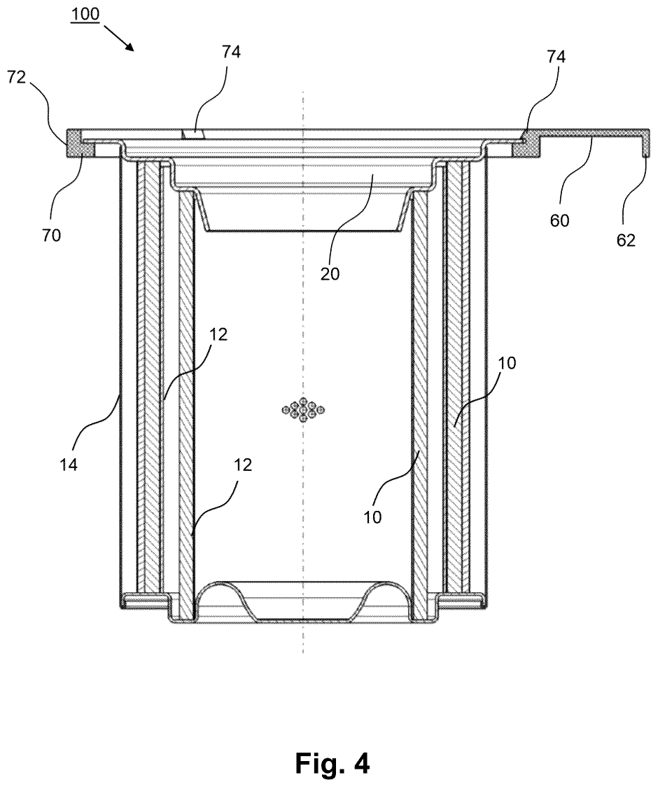

Same or similar embodiments, elements or features are provided in the FIGS. 1 through 10 with identical reference characters.

### DETAILED DESCRIPTION

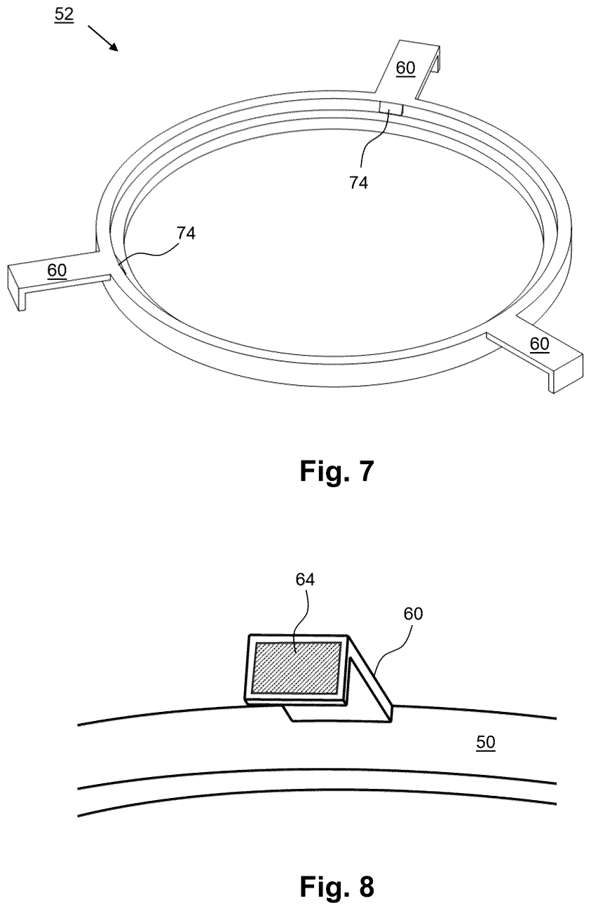

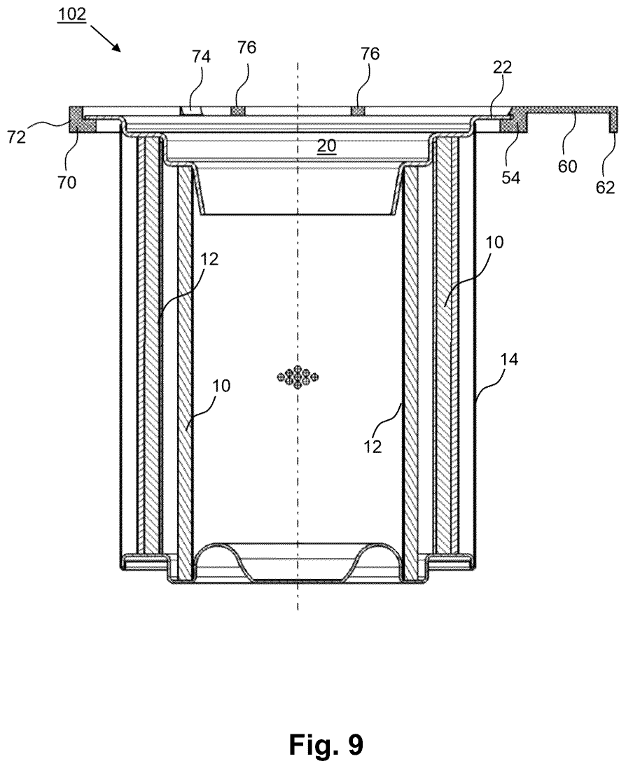

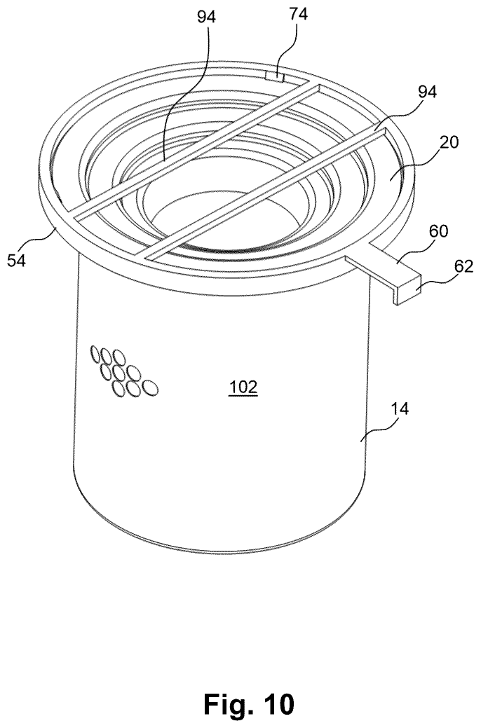

The following explanations with respect to the configurations, features, and advantages of the present invention (if nothing else is indicated) relate to the first embodiment illustrated in FIGS. 1 through 6 for a seal element 50 according to the present invention as well as to the second embodiment illustrated in FIG. 7 for a seal element 52 according to the present invention as well as to the third embodiment illustrated in FIGS. 9 and 10 for a seal element 54 according to the present invention.

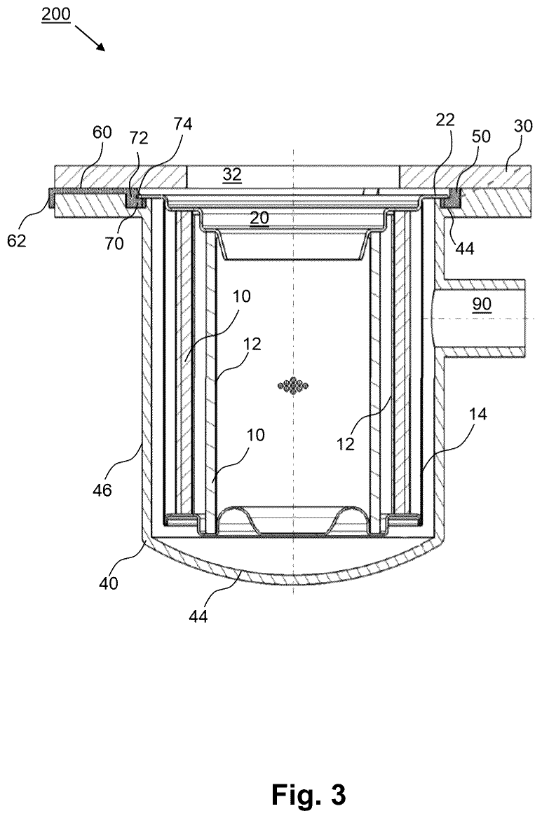

The liquid separator 200 illustrated in FIG. 1 comprises a coalescing filter insert 100 with a separation element 10 of a hollow-cylindrical shape. The separation element 10 is configured to separate liquid, in particular oil and/or oil aerosol, by means of the coalescence principle from a gas flow flowing radially and/or tangentially into the separation element 10. The separation element 10, as illustrated in FIG. 3, can comprise a plurality, for example, two, filter layers which are formed of the same or of different materials, for example of glass fiber and/or of plastic material, for example, of nonwoven.

According to the method of the present invention, the coalescing filter insert 100 is exchangeably arranged in a hollow cylindrical interior of a pressure vessel, embodied according to the present invention, of a liquid separator 200 embodied according to the present invention.

As illustrated in FIG. 1, the coalescing filter insert 100 can be installed exchangeably in a pressure-resistant housing 30, 40 of the pressure vessel. For installation in the pressure vessel, the coalescing filter insert 100 comprises a flange 20 which is arranged at the end face at the separation element 10 and can be clamped between a cover 30 and a cylinder-shaped body 40 of the pressure vessel of the liquid separator 200. The cover 30 is removably and detachably connectable to the cylinder-shaped body 40 of the pressure vessel.

In the embodiment of the pressure vessel illustrated in FIG. 1, the cover 30 is in particular of an annular disk-shaped configuration and the cylinder-shaped body 40 comprises an annular disk-shaped collar 48 configured for supporting, in particular for placing, the cover 30 on the cylinder-shaped body 40. Cover 30 and collar 48 can be connected to each other by at least one connection means, for example, by at least one screw or by at least one fastening means which provides a clamping connection. As an alternative, it is also possible that the cover 30 and the cylinder-shaped body 40, for example, the radial rim of the collar 48, comprise a thread and can be screwed to each other.

The body 40 of the pressure vessel has advantageously a tangentially arranged raw air inlet 90 which is connected to a connection element, for example, with a compressor screw. When presently tangential, radial, axial, coaxial or circumferential or the like is mentioned, this relates to the longitudinal axis of the liquid separator 200, if nothing else is indicated.

Through the raw air inlet 90, compressed air laden with oil aerosol enters the interior of the pressure vessel and then flows spirally through an annular gap arranged between the pressure vessel body 40 and the separation element 10 prior to flowing into the separation element 10 of the coalescing filter insert 100 at a lower region which is facing away from the cover 30 and then flows through the latter in radial direction from the exterior to the interior.

The purified clean air flows in axial direction out of the cover 30 of the pressure vessel. For discharging the clean air, the cover 30 comprises a central clean air outlet 32. The flange 20 is arranged coaxially to the clean air outlet 32 of the liquid separator 200.

As illustrated in FIG. 1, the flange 20 of the coalescing filter insert 100 comprises at least at its radial outer rim a support surface 22 which is configured to be supported on an upper support region 42 of the body 40 of the pressure vessel which is facing the cover 30. The support region 42 of the body 40 can be provided by a radially inwardly arranged cutout, for example, an annular groove, of the annular disk-shaped collar 48 of the pressure vessel.

For sealing the hollow-cylindrical interior of the pressure vessel in relation to the ambient pressure, a seal element 50; 52; 54 is arranged at the support surface 22 of the flange 20.

As shown in FIG. 3, the seal element 50 advantageously comprises a seal body in particular of an annular configuration, which surrounds the outer rim of the flange 20 and is configured for sealing the interior of the pressure vessel in relation to the ambient pressure.

The seal body has advantageously
a first seal surface 70 which is arranged parallel to the flange 20 and contacts directly an underside of the flange 20 which faces the separation element 10, and
a further seal surface 72 which is arranged perpendicularly to the flange 20 and contacts directly the radial outer rim of the flange 20.

In order to provide a particularly material-saving sealing action, the first seal surface 70 and the further seal surface 72 are advantageously arranged relative to each other in an L-shape or substantially an L-shape. As an alternative, the two seal surfaces 70, 72 can also be arranged in a V-shape or U-shape relative to each other however.

Independent thereof or in combination therewith, the seal element is advantageously captively held at the separation element, thus a component of the separation element and no individual part. This has the advantage that, when exchanging the separation element in the prescribed servicing intervals, the seal element is also reliably exchanged. In the prior art, in which the seal element is not captively arranged at the separation element, the seal element may be forgotten so that the function of the liquid separator is impaired or not fulfilled.

For attaching the seal element 50; 52; 54 to the flange 20, it comprises advantageously at least one holding projection 74. Depending on the size of the seal element 50; 52; 54, it can comprise, for example, 3, 6, 9, or 12 holding projections 74 which are preferably symmetrically arranged at the seal element. The holding projection 74 can be configured, for example, as a nose-type holding element. Advantageously, the holding projection 74 is configured such that it
extends radially inwardly away from an upper region of the further seal surface 72 facing away from the separation element 10;
contacts directly a top side of the flange 20 facing away from the separation element 10;
is arranged parallel to the first seal surface 70; and
interacts such with the first seal surface 70 that the seal element 50; 52; 54 is clamped captively at the flange.

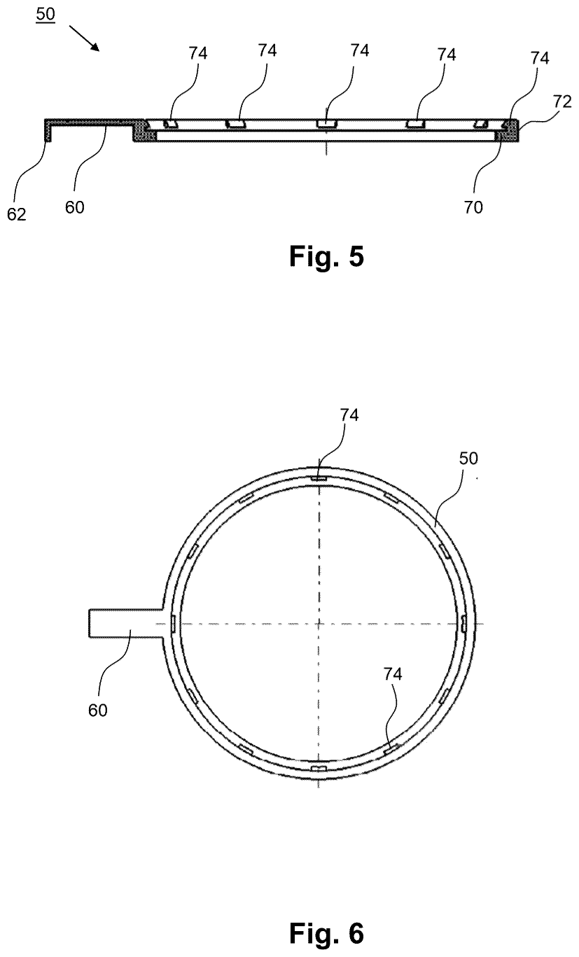

As shown in FIGS. 5, 6, and 7, the contact surface which is formed between holding projection 74 and flange 20 is advantageously smaller than the contact surface formed between the first seal surface 70 and the flange 20. In this context, the holding projection 74 projects only partially toward the flange 20, is thus arranged only at a portion of the top side of the flange 20 which is positioned opposite the first seal surface 70. In other words, the radial extension of the holding projection 74 is less than the radial extension of the first seal surface 70. A holding projection 74 formed in this way can be manufactured particularly simply and inexpensively.

According to the invention, the seal element 50 comprises at least one seal element extension 60 extending radially outwardly away from the flange 20, in particular a stay or an arm. As is illustrated in FIGS. 1 through 6, the seal element extension 60 extends radially outwardly away from the seal body of the seal element 50 and projects in the position of use of the coalescing filter insert 100 in such a way through the housing 30, 40 of the pressure vessel that a radially outer region of the seal element extension 60 can be seen from the exterior of the pressure vessel.

A marking 64, in particular a code, for example, a so-called RFID code, on a radially outer end surface 62 of the seal element extension 60 which is visible when the pressure vessel is closed enables the identification of a seal element 50, 52, 54 arranged in the pressure vessel when the pressure vessel is closed.

The radially outer end surface 62 of the seal element extension 60 can be configured like a tab which extends at an angle in relation to the seal element extension 60, for example, is arranged perpendicularly to the seal element extension 60, and is arranged at the outer side of the body 40, in particular of the collar 48, of the pressure vessel.

The seal element extension 60 extends through a radial cutout region 82 of a seal element cutout 80 of the body 40 of the pressure vessel. This radial cutout region 82 shows the seal element extension 60 like a viewing window. The seal element 50; 52; 54 is thus visible even after its installation in the pressure vessel.

The seal elements 50; 52; 54 illustrated in FIGS. 1 through 10 differ in the number of their seal element extensions 60. The seal element 50; 52; 54 can comprise, for example, one, three or four seal element extensions 60. Furthermore, as illustrated in FIGS. 9 and 10, the seal element 54 can comprise at least one stay-like grip element 76 that extends through the radial inner cutout of the seal element 54 and serves for better handling of the coalescing filter insert 100; 102. Seal element extension 60 and grip element 76 facilitate respectively mounting as well as demounting of the coalescing filter insert 100; 102 in the pressure vessel.

### REFERENCE CHARACTERS

10 separator element for separating oil and oil aerosol from air by means of the coalescence principle, in particular hollow cylinder-shaped coalescing device, for example, of glass fiber and/or of plastic material, for example, of nonwoven
12 optional support pipe, in particular perforated sheet comprising air passage openings or expanded metal comprising air passage openings, for supporting the separator element 10 in relation to the pressure of the fluid flowing through the separator element
14 optional protective element, in particular grid-like perforated metallic protective tube surrounding the outer jacket surface of the separator element 10
20 flange, in particular end face end disk, of the filter insert 100 for supporting the filter insert 100 between the cover 30 and the housing body 40 of the liquid separator 200
22 support surface of the flange 20 for supporting the flange 20 on the body 40 of the pressure vessel
30 cover or housing cover, in particular pressure vessel cover or pressure storage vessel cover, for example, housing socket
32 clean air outlet of the cover 30
40 body or housing body of the pressure vessel, in particular cylinder-shaped pressure-resistant housing body or pressure vessel bottom part or pressure storage vessel bottom part
42 upper support region of the body 40 of the pressure vessel embodied for supporting the flange 20
44 pressure vessel inner side
46 pressure vessel outer side
48 annular disk-shaped collar of the body 40 for supporting the cover 30 on the cylinder-shaped body 40
50 seal element, in particular seal ring, in particular with L-shaped cross section, first embodiment
52 seal element, in particular seal ring, in particular with L-shaped cross section, second embodiment
54 seal element, in particular seal ring, in particular with L-shaped cross section, third embodiment
60 seal element extension, in particular radially outwardly extending tab, projection, stay, or arm of the seal element 50, 52, 54
62 radially outer end surface, in particular visible surface, for example, visible surface arrangeable at the outer side of the collar 48, of the seal element extension 60
64 marking and/or code for identification of the seal element 50, 52, 54 or of the coalescing filter insert 100, 102
70 first seal surface of the seal element 50, 52, 54
72 further seal surface of the seal element 50, 52, 54
74 holding projection or holding nose of the seal element 50, 52, 54
76 grip element of the seal element 54 (compare FIGS. 9 and 10)
80 seal element cutout
82 radially extending cutout region of the seal element cutout
90 raw air inlet
100 coalescing filter insert first embodiment (compare FIGS. 1, 3 and 4)
102 coalescing filter insert second embodiment (compare FIGS. 9 and 10)
200 liquid separator

What is claimed is:

1. A coalescing filter insert for installation in a hollow-cylindrical interior of a pressure vessel of a liquid separator, the coalescing filter insert comprising:
at least one separator element comprising a hollow cylinder shape and configured to separate a liquid and/or an aerosol from a gas flow by coalescence;
an annular disk-shaped flange arranged at an end face of the at least one separator element and configured to be exchangeably arranged between a cover of the pressure vessel and a cylinder-shaped body of the pressure vessel, wherein the annular disk-shaped flange comprises a support surface disposed at least at a radially outer rim of the annular disk-shaped flange, wherein the support surface is configured to be supported on an upper support region of the cylinder-shaped body of the pressure vessel, wherein the upper support region faces the cover;
at least one seal element arranged at the support surface of the annular disk-shaped flange such that, in a position of use of the coalescing filter insert in the pressure vessel, the at least one seal element seals the hollow-cylindrical interior of the pressure vessel in relation to an ambient pressure;
wherein the at least one seal element comprises at least one seal element extension extending radially outwardly away from the support surface of the annular disk-shaped flange; and
wherein the at least one seal element extension is configured to be arranged between the cover of the pressure vessel and the cylinder-shaped body of the pressure vessel and is configured to project through the pressure vessel in the position of use of the coalescing filter insert.

2. The coalescing filter insert according to claim 1, wherein the at least one seal element extension comprises, at a radially outer rim thereof, at least one radially outer end surface configured for applying at least one marking and/or at least one code thereon.

3. The coalescing filter insert according to claim 2, wherein the at least one radially outer end surface is a visible surface in the position of use and is arranged at an angle in relation to a main body of the at least one seal element extension.

4. The coalescing filter insert according to claim 2, wherein the at least one marking and/or the at least one code is configured to provide an identification of the at least one seal element and/or to provide an identification of the coalescing filter insert and is arranged on the at least one radially outer end surface.

5. The coalescing filter insert according to claim 4, wherein the at least one code includes a code configured for identification by electromagnetic waves.

6. The coalescing filter insert according to claim 1, wherein the at least one seal element extension includes at least two seal element extensions arranged symmetrically at the at least one seal element.

7. The coalescing filter insert according to claim 1, wherein the at least one seal element comprises a seal body surrounding the radially outer rim of the annular disk-shaped flange, wherein the seal body comprises an annular shape, wherein the at least one seal element extension extends radially outwardly away from the seal body.

8. The coalescing filter insert according to claim 7, wherein the seal body comprises a first seal surface arranged parallel to the annular disk-shaped flange, wherein the first seal surface contacts directly an underside of the annular disk-shaped flange, wherein the underside of the annular disk-shaped flange faces the at least one separator element, wherein the seal body comprises a second seal surface arranged perpendicularly to the annular disk-shaped flange, wherein the second seal surface contacts directly the radially outer rim of the annular disk-shaped flange, wherein the first seal surface and the second seal surface are arranged in relation to each other in an L-shape or substantially an L-shape.

9. The coalescing filter insert according to claim 8, wherein the at least one seal element comprises at least one holding projection, wherein the at least one holding projection extends radially inwardly away from an upper region of the second seal surface which faces away from the at least one separation element, wherein the at least one holding projection interacts with the first seal surface such that the at least one seal element is clamped captively at the annular disk-shaped flange.

10. The coalescing filter insert according to claim 1, wherein the at least one seal element comprises a seal body surrounding the radially outer rim of the annular disk-shaped flange, wherein the seal body comprises an annular shape, wherein the at least one seal element comprises at least one grip element extending from the seal body radially inwardly and connecting at least two spaced apart regions of the seal body to each other.

11. The coalescing filter insert according to claim 10, wherein the at least one grip element comprises at least one core comprised of at least one strong or hard material, wherein the at least one strong or hard material is selected from the group consisting of metal, wood, and plastic material, wherein the at least one core is enveloped by at least one elastic material.

12. A coalescing filter insert for installation in a hollow-cylindrical interior of a pressure vessel of a liquid separator, the coalescing filter insert comprising:
at least one separator element comprising a hollow cylinder shape and configured to separate a liquid and/or an aerosol from a gas flow by coalescence;
an annular disk-shaped flange arranged at an end face of the at least one separator element and configured to be exchangeably arranged between a cover of the pressure vessel and a cylinder-shaped body of the pressure vessel, wherein the annular disk-shaped flange comprises a support surface disposed at least at a radially outer rim of the annular disk-shaped flange, wherein the support surface is configured to be supported on an upper support region of the cylinder-shaped body of the pressure vessel, wherein the upper support region faces the cover;
at least one seal element arranged at the support surface of the annular disk-shaped flange such that, in a position of use of the coalescing filter insert in the pressure vessel, the at least one seal element seals the hollow-cylindrical interior of the pressure vessel in relation to an ambient pressure;
wherein the at least one seal element comprises a seal body surrounding the radially outer rim of the annular disk-shaped flange, wherein the seal body comprises an annular shape;
wherein the at least one seal element comprises at least one grip element extending from the seal body radially inwardly and connecting at least two spaced apart regions of the seal body to each other.

13. The coalescing filter insert according to claim 12, wherein the at least one grip element comprises at least one core comprised of at least one strong or hard material, wherein the at least one strong or hard material is selected from the group consisting of metal, wood, and plastic material, wherein the at least one core is enveloped by at least one elastic material.

14. A pressure vessel comprising:
a housing opening;
a cylinder-shaped body configured to accommodate a coalescing filter insert;
an annular disk-shaped cover comprising a central clean air outlet and configured to close the housing opening;
at least one seal element cutout configured to seal-tightly arrange a seal element of the coalescing filter insert between the cylinder-shaped body and the annular disk-shaped cover;
wherein the at least one seal element cutout comprises at least one radial cutout region extending from a pressure vessel inner side facing an interior of the pressure vessel all the way to a radially outwardly arranged pressure vessel outer side facing away from the interior of the pressure vessel and loaded by an ambient pressure.

15. The pressure vessel according to claim 14, wherein the cylinder-shaped body comprises an annular disk-shaped collar configured to support the annular disk-shaped cover, wherein the at least one seal element cutout extends through the annular disk-shaped collar.

16. The pressure vessel according to claim 15, wherein the at least one seal element cutout extends through the annular disk-shaped collar from the pressure vessel inner side all the way to the pressure vessel outer side.

17. A liquid separator comprising:
a pressure vessel comprising a housing opening; a cylinder-shaped body; an annular disk-shaped cover comprising a central clean air outlet and configured to close the housing opening; and at least one seal element cutout;
wherein the at least one seal element cutout comprises at least one radial cutout region extending from a pressure vessel inner side facing an interior of the pressure vessel all the way to a radially outwardly arranged pressure vessel outer side facing away from the interior of the pressure vessel and loaded by an ambient pressure;
a coalescing filter insert arranged in an interior of the pressure vessel in the cylinder-shaped body configured to accommodate the coalescing filter insert, wherein the coalescing filter insert comprises:
at least one separator element comprising a hollow cylinder shape and configured to separate a liquid and/or an aerosol from a gas flow by coalescence;
an annular disk-shaped flange arranged at an end face of the at least one separator element and configured to be exchangeably arranged between the annular disk-shaped cover of the pressure vessel and the cylinder-shaped body of the pressure vessel, wherein the annular disk-shaped flange comprises a support surface disposed at least at a radially outer rim of the annular disk-shaped flange, wherein the support surface is supported on an upper support region of the cylinder-shaped body of the pressure vessel, wherein the upper support region faces the cover of the pressure vessel;
at least one seal element arranged at the support surface of the annular disk-shaped flange such that the at least one seal element seals the interior of the pressure vessel in relation to an ambient pressure;
wherein the at least one seal element comprises at least one seal element extension extending radially outwardly away from the support surface of the annular disk-shaped flange; and
wherein the at least one seal element extension is seal-tightly arranged between the annular disk-shaped cover of the pressure vessel and the cylinder-shaped body of the pressure vessel in the at least one seal element cutout and projects through the pressure vessel in a position of use of the at least one seal element in the pressure vessel.

18. The liquid separator according to claim 17, wherein the at least one radial cutout region of the pressure vessel is embodied corresponding to a geometry of the at least one seal element.

19. The liquid separator according to claim 18, wherein the at least one radial cutout region of the pressure vessel is embodied so as to correspond to a geometry of the at least one seal element extension of the at least one seal element.
